(19) United States
(12) Patent Application Publication
(10) Pub. No.: US 2004/0207520 A1
(43) Pub. Date: Oct. 21, 2004

(54) Turn signal of bicycle

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/418,934

(22) Filed: Apr. 18, 2003

(51) Int. Cl. B60Q 1/34

(52) U.S. Cl. 340/475; 340/432

(57) ABSTRACT

A turn signal is provided for installment on a bicycle with a handle. The turning signal includes a transmitting device attached to the handle for transmitting a wireless signal, a receiving device attached to the bicycle for receiving the wireless signal, and a light electrically connected with the receiving device for signaling an intention to turn the bicycle.

### FIELD OF INVENTION

The present invention relates to a bicycle and, more particularly, to a turn signal of a bicycle.

### BACKGROUND OF INVENTION

Taiwanese Patent Publication No. 405559 discloses a turn signal of a bicycle. The turn signal includes a lens 10, a reflector 30, a circuit 20 installed in the reflector 30, a cap 40 for keeping a battery in the reflector 30 and a plug 50 secured to the cap 40. A switch 24 is mounted on the reflector 30 and connected with the circuit 20. The bicycle includes a right grip 61 and a left grip 61. A right turn signal is attached to the right grip 61 through inserting its plug 50 in the right grip 61. A left turn signal is attached to the left grip 61 through inserting its plug 50 in the left grip 61. However, the turn signals are not easily observable from the back.

The present invention is therefore intended to obviate or at least alleviate the problem encountered in prior art.

### SUMMARY OF INVENTION

It is the primary objective of the present invention to provide a turn signal that is easily observable from the back.

To achieve this objective, the turning signal includes a transmitting device attached to the handle for transmitting a wireless signal, a receiving device attached to the bicycle for receiving the wireless signal, and a light electrically connected with the receiving device for signaling an intention to turn the bicycle.

It is another objective of the present invention to provide a turn signal that is easily observable from the front and the back.

To achieve this objective, the turning signal includes a transmitting device attached to the handle for transmitting a wireless signal, a front light electrically connected with the transmitting device for signaling an intention to turn the bicycle, a receiving device attached to the bicycle for receiving the wireless signal, and a rear light electrically connected with the receiving device for signaling an intention to turn the bicycle.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a perspective view of a according to the present invention.

FIG. 2 is an exploded view of the shown in FIG. 1.

FIG. 3 is a cross-sectional view of the shown in FIG. 1.

### DETAILED DESCRIPTION OF EMBODIMENTS

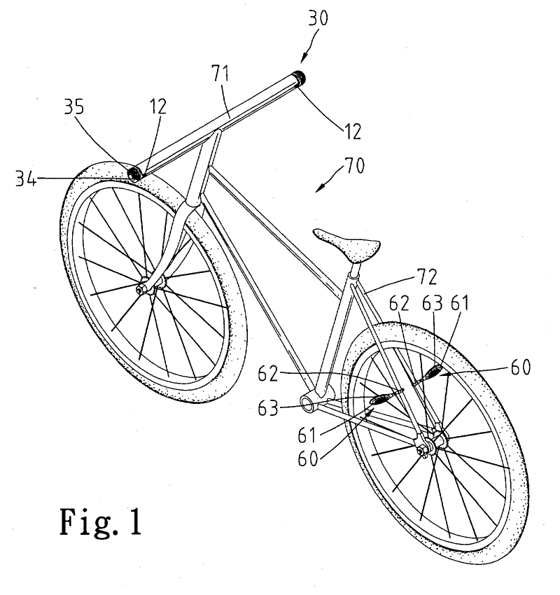

Referring to FIG. 1, a bicycle 70 includes a handle 71 with two ends and a rear fork 72 with two prongs. According to a first embodiment of the present invention, a turn signal includes a transmitting unit 30 attached to the right or left end of the handle 71 and a receiving unit 60 attached to the right or left prong of the rear fork 72.

A rider can operate the transmitting unit 30 so as to transmit a wireless signal to the receiving unit 60. On receiving the wireless signal, the receiving unit 60 provides light in order to signal the rider's intention to turn right or left.

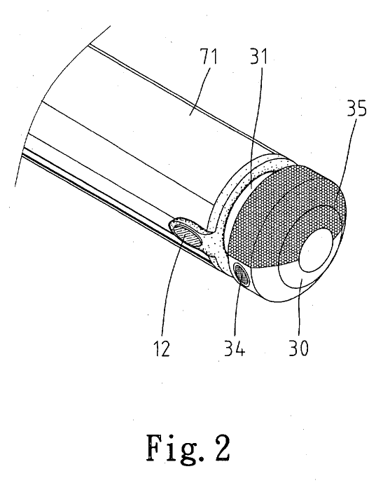

FIGS. 2˜5 show that the transmitting device 30 is attached to the right end of the handle 71.

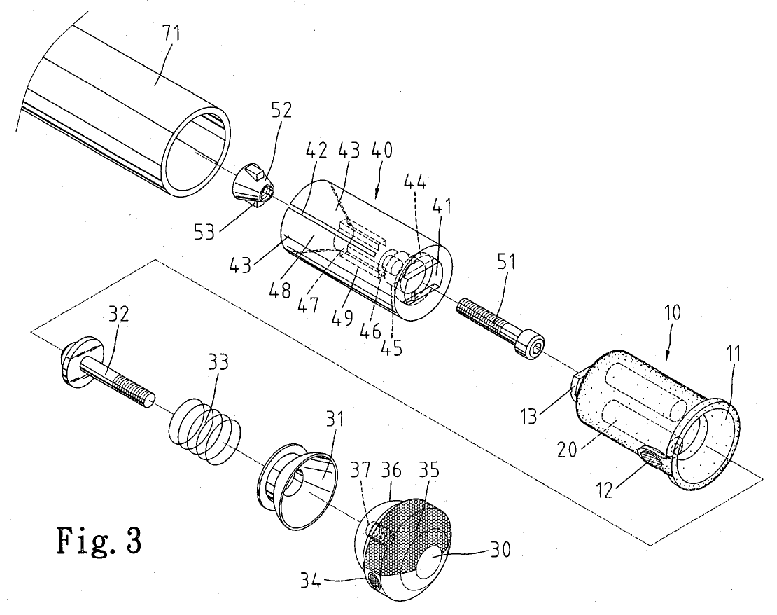

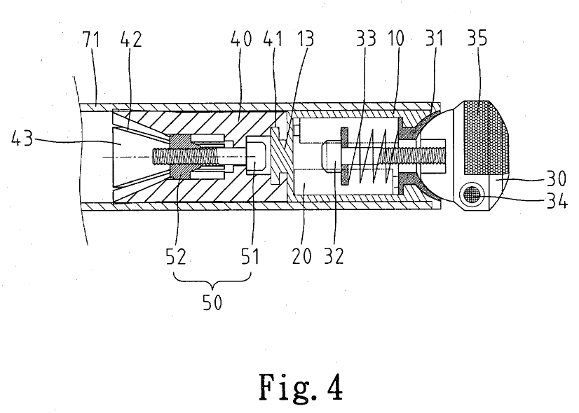

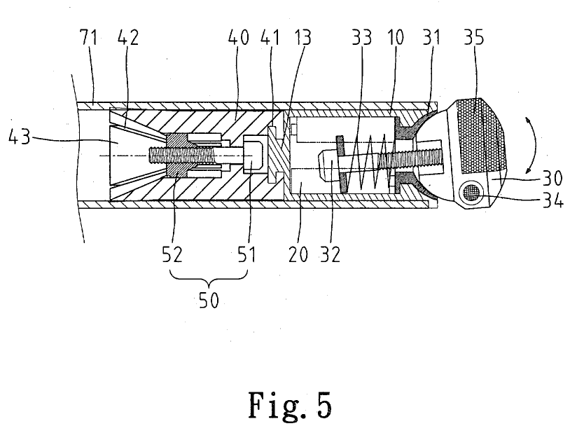

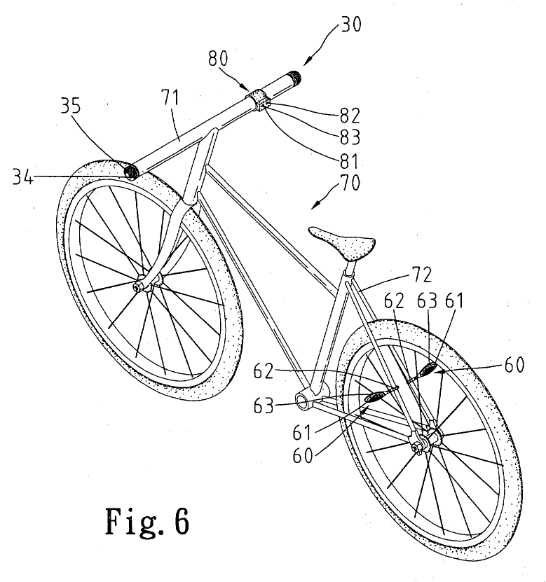

Referring to FIGS. 3 and 4, a plug 40 is fit in the right end of the handle 71. An adjusting device 50 is used for adjusting the extent to which the plug 40 abuts against an internal face of the right end of the handle 71. A housing 10 is connected with the plug 40. A power supply 20 is put in the housing 10. The transmitting unit 30 is connected with the housing 10 and electrically connected with the power supply 20.

The plug 40 defines a tunnel extending throughout its axis. The tunnel includes an oblong section 41, a first circular section 44, a second circular section 45, a third circular section 46, a fourth circular section 47 and a conical section 48. Two grooves 49 are communicated with the fourth circular section 47 of the tunnel. The plug 40 includes several slits 42, thus dividing the plug 40 into a corresponding number of claws 43.

The adjusting device 50 includes a bolt 51 and a conical nut 52. The bolt 51 is inserted into the circular sections 46 and 47 of the tunnel. An enlarged head of the bolt 51 is retained in the second circular section 45 of the tunnel. The conical nut 52 is put in the conical section 48 of the tunnel. Two fins 53 formed on the conical nut 52 are inserted in the grooves 49, thus avoiding rotation of the conical nut 52 relative to the plug 40. The conical nut 52 is engaged with the bolt 51. The plug 40 is fit into the right end of the handle 71. The conical nut 52 can be moved towards the enlarged of the bolt 51 by rotating the bolt 51, thus pushing the claws 43 outwardly for tighter abutment against the internal face of the right end of the handle 71.

The housing 10 includes a first end at which a socket 11 is formed and a second end at which an anchor 13 is formed. A switch 12 is mounted on the housing 10. The anchor 13 includes a cylindrical portion and an oblong portion.

The power supply 20 includes two batteries put in the housing 10. The power supply 20 is electrically connected with the switch 12.

The transmitting unit 30 includes a transmitter 34, a light 35 and a support 36 on which the transmitter 34 and the light 35 are mounted. The support 36 is shaped like a portion of a ball. A buffer 31 is put in the socket 11. A bolt 32 and a spring 33 are put in the housing 10. The spring 33 is mounted on the bolt 32. The support 36 is put in the buffer 31. The bolt 32 is driven into a hole 37 defined in the transmitting unit 30, thus connecting the transmitting unit 30 with the housing 10. Thus, the support 36 and the socket 11 form a ball-and-socket mechanism, i.e., rotation of the support 36 relative to the socket 11 is allowed.

The oblong portion of the anchor 13 is put in the first circular section 44 through the oblong section 41 of the tunnel. Then, the anchor 13 is rotated, thus attaching the housing 10 to the plug 40.

Referring to FIGS. 4 and 5, the transmitting unit 30 is pivotal relative to the housing 10

Referring to FIG. 1, the receiving unit 60 includes a light 61, a clip 62 and a receiver 63. Because of the clip 62, the receiving unit 60 can be held in any proper position on the right or left prong of the fork 72. The receiver 63 can receive the wireless signal from the transmitter 34. On receiving the wireless signal, the receiver 63 turns on the light 61.

FIG. 6 shows two turn signals according to a second embodiment of the present invention. The second embodiment is identical to the first embodiment but including a selection unit 80 instead of the switch 12. The selection unit 80 includes two buttons 81 and 82. Via pressing one of the buttons 81 and 82, the rider can actuate the transmitter 34 of the turn signal mounted on one of the ends of the handle 71. The rider can easily reach the buttons 81 and 82 with the thumb of his right hand. The selection unit 80 may alternatively include a transmitter 83 instead of the transmitter 34.

The present invention has been described via detailed illustration of two embodiments. Those skilled in the art can derive variations from the embodiments without departing from the scope of the present invention. Therefore, the embodiments shall not limit the scope of the present invention defined in the claims.

What is claimed is:

1. A turn signal for installment on a bicycle with a handle, the turning signal including:
a transmitting device attached to the handle for transmitting a wireless signal;
a receiving device attached to the bicycle for receiving the wireless signal; and
a light electrically connected with the receiving device for signaling an intention to turn the bicycle.

2. The turn signal according to claim 1 including a power supply electrically connected with the transmitting device.

3. The turn signal according to claim 2 including a housing attached to the handle for receiving the power supply and the transmitting device.

4. The turn signal according to claim 3 wherein the housing is inserted in the handle.

5. The turn signal according to claim 4 including a plug fit in the handle and connected with the housing.

6. The turn signal according to claim 5 wherein the housing includes an anchor formed thereon, and the plug defines a recess for trapping the anchoring.

7. The turn signal according to claim 6 wherein the anchor includes a body and an oblong head, and the recess includes a circular section and an oblong section through which the oblong head of the anchor is movable into the circular section of the recess, and the oblong head of the anchor can then be rotated in the circular section of the recess so that the oblong head of the anchor is not aligned with the oblong section of the recess.

8. The turn signal according to claim 5 including an adjusting device for adjusting an extent to which the plug abuts the handle.

9. The turn signal according to claim 8 wherein the plug defines a conical recess, and the adjusting device includes a conical element movable in the conical recess in a direction for enhancing the abutment of the plug against the handle and an opposite direction for easing the abutment of the plug against the handle.

10. The turn signal according to claim 9 wherein the plug defines a tunnel, and the adjusting device includes a bolt inserted through the tunnel, and the conical element is a nut for engagement with the bolt, thus rotation of the bolt relative to the conical nut causes the movement of the conical nut in the conical recess.

11. The turn signal according to claim 10 wherein the plug defines two grooves communicated with the tunnel, and the conical nut includes two fins put in the grooves, thus avoiding rotation of the conical nut in the plug.

12. The turn signal according to claim 3 wherein the transmitting device includes a transmitter and a support on which the transmitter is mounted.

13. The turn signal according to claim 12 wherein the housing includes a socket formed thereon for receiving the support in a ball-and-socket manner.

14. The turn signal according to claim 13 including a buffer arranged between the socket and the support.

15. The turn signal according to claim 13 including a bolt driven into a hole defined in the support through a hole defined in the socket.

16. The turn signal according to claim 15 including a spring compressed by the socket and an enlarged head of the bolt.

17. The turn signal according to claim 1 including a light electrically connected with the transmitting device.

18. The turn signal according to claim 1 including a switch that is operable for turning on and off the transmitting device.
